(19) United States
(12) Patent Application Publication
(10) Pub. No.: US 2017/0329963 A1
(43) Pub. Date: Nov. 16, 2017

(54) METHOD FOR DATA PROTECTION USING ISOLATED ENVIRONMENT IN MOBILE DEVICE

(71) Applicant: Huawei International Pte., Ltd., Singapore (SG)

(72) Inventors: Zhengde ZHAI, Beijing (CN); Hai GAO, Singapore (SG); Xuejun WEN, Singapore (SG); Chengkang CHU, Singapore (SG); Tieyan LI, Singapore (SG)

(21) Appl. No.: 15/663,237

(22) Filed: Jul. 28, 2017

Related U.S. Application Data
(63) Continuation of application No. PCT/SG2016/050042, filed on Jan. 28, 2016.

(30) Foreign Application Priority Data
Jan. 29, 2015 (SG) SG10201500698Y

(51) Int. Cl. G06F 21/53; G06F 21/62; H04W 12/02; G06F 21/54; H04W 4/00; G06F 21/60; G06F 21/50

(52) U.S. Cl. CPC G06F 21/53; H04W 12/02; G06F 21/62; G06F 21/54; G06F 21/604; G06F 21/50; H04W 4/001

(57) ABSTRACT

Embodiments of the application provide a mobile device architecture having non-protected environment and one or more protected containers for isolating application programs and application data according to their sensitivity or privacy levels. Access policy and exception policy are defined for each protected container to limit access to application program and data associated with or stored in the protected container(s). A communication monitor module is provided to implement the access and exception policy, and manage communication in the mobile device, including intra-container communication, inter-container communication and communication to and from the non-protected environment.

### CROSS-REFERENCE TO RELATED APPLICATIONS

This application is a continuation of International Application No. PCT/SG2016/050042, filed on Jan. 28, 2016, which claims priority to Singapore Patent Application No. SG10201500698Y, filed on Jan. 29, 2015. The disclosures of the aforementioned applications are hereby incorporated by reference in their entireties.

### FIELD OF APPLICATION

The application relates to data protection in mobile device, and more particularly to protecting data using one or more isolated environments.

### BACKGROUND

In recent years, intelligent terminals, including mobile computing or communication devices, have become an indispensable personal item. People store their personal data such as contacts, messages or photos in mobile devices for easy access. Therefore, the security of mobile devices has become a personal privacy issue.

Unfortunately, the storage environment on a mobile device is not protected because the operating platform is usually open to third-party developers. Mobile device users can install many applications (Apps) from App markets. Some of these Apps may be malicious and are configured to steal user's personal data. In a non-protected environment, stored data can be controlled by any or other Apps and can be accessed via Inter-Process Communication (IPC). However, blocking all access by other Apps is not practical on an open platform. Accordingly, mobile device users are in need of security techniques to protect their privacy and data in mobile devices.

Data on intelligent terminals can be classified according to privacy. For example, contact information stored in address book and relating to famous persons or public figures is considered sensitive, whereas an e-mail of advertisement nature is non-sensitive. Typically, mobile device users may not take issue with leakage of non-sensitive data. However, leakage of sensitive data could result in dire consequences and is therefore unacceptable to users.

In US Patent Application Publication No. US 2014/0006347 A1, a system is disclosed that includes components and features for enabling enterprise users to securely access enterprise resources (documents, data, application servers, etc.) using their mobile devices. An enterprise can use some or all components of the system to, for example, securely but flexibly implement a BYOD (bring your own device) policy in which users can run both personal applications and protected enterprise applications on their mobile devices. The system may, for example, implement policies for controlling mobile device accesses to enterprise resources based on device attributes (e.g., what mobile applications are installed), user attributes (e.g., the user's position or department), behavioral attributes, and other criteria. Client-side code installed on the mobile devices may further enhance security by, for example, creating a protected container for locally storing enterprise data, creating a protected execution environment for running enterprise applications, and/or creating protected application tunnels for communicating with the enterprise system.

International Publication No. WO 2014/067222 A1 discloses a system for isolating mobile data. The system comprises a tag control management module and a mobile data management module. The tag control management module comprises a tag generator, tag storage management and tag transmission control. The mobile data management module mainly identifies the user permission and a data privacy level according to a tag and performs operational control on a mobile application of the mobile data, so as to achieve maintained security protection on the fine-grained mobile data. The mobile data management module is divided into security isolation control during data processing, security control during data transmission and security isolation control during data storage. Also disclosed at the same time is a method for isolating mobile data. The present application can effectively isolate the data of a mobile intelligent terminal, perform operational control on the fine-grained data, achieve different privacy policies, and guarantee the maintained security of mobile data.

In Chinese Patent Application Publication No. CN103313238, the application discloses a safety system for a mobile terminal. The safety system comprises a user data isolation module; the user data isolation module comprises a user authority management module and a data protection module and is used for protecting privacy data of a user; the user can enter standby interfaces corresponding to different authority passwords by the aid of the user authority management module; the data protection module is arranged between application and a database interface and is used for managing user data access authority of application programs. The application further discloses a safety protection method for the mobile terminal. The safety system and the safety protection method have the advantages that the real data can be protected by the system for the mobile terminal, personal information of the mobile terminal is prevented from being revealed or stolen, and the privacy information of the user can be effectively protected.

### SUMMARY

Embodiments of the application provide a mobile device architecture having non-protected environment and one or more protected containers for isolating application programs and application data according to their sensitivity or privacy levels. Access policy and exception policy are defined for each protected container to limit access to application program and data associated with or stored in the protected container(s). A communication monitor module is provided to implement the access and exception policy, and manage communication in the mobile device, including intra-container communication, inter-container communication and communication to and from the non-protected environment.

According to a first embodiment, a mobile device comprises a computer-readable storage and a processor communicably coupled to the processor, the computer-readable storage including:
a non-protected environment which is configured to store at least a non-protected application program and a non-protected application data associated with the non-protected application program,
a first protected container which is logically separate from the non-protected environment, and configured to store a first plurality of protected application programs and a first protected application data associated with the first plurality of protected application programs, and
a communication monitor module communicably coupled to the non-protected environment and the first protected container, and configured to manage access to the first protected application data by implementing a first access policy wherein the first protected application data is accessible to the first plurality of protected application programs, and wherein the first protected application data is inaccessible to the non-protected application program unless a first exception policy is complied with.

In this first embodiment, the first access policy may further include the non-protected application data is accessible to any of the first plurality of protected application programs and the non-protected application program.

In this first embodiment, the first protected container may further include: a first authentication module configured to verify receipt of an authorized first passcode associated with the first plurality of protected programs, and a first cryptography module configured to render the first protected application data in encrypted form if the authorized first password is not received, and in decrypted form if the authorized first password is received.

According to a second embodiment of the application, in addition to the aforementioned described in the first embodiment, the computer-readable storage further includes:
a second protected container which is logically separate from the non-protected environment and the first protected container, and configured to store a second plurality of protected application programs and a second protected application data associated with the second plurality of protected application programs,
wherein the communication monitor module is further communicably coupled to the second protected container, and configured to manage access to the second protected application data by implementing a second access policy wherein the second protected application data is accessible to the second plurality of protected application programs, and wherein the second protected application data is inaccessible to the non-protected application program unless a second exception policy is complied with.

In this second embodiment, the second access policy may further include the second protected application data is inaccessible to the first protected application program unless both the first exception policy and the second exception policy are complied with, wherein the first access policy further includes the first protected application data is inaccessible to the second protected application program unless both the first exception policy and the second exception policy are complied with.

According to a third embodiment of the application, in addition to the aforementioned described in the first embodiment, the computer-readable storage further includes:
a second protected container which is logically separate from the non-protected environment and the first protected container, and configured to store a second plurality of protected application programs and a second protected application data associated with the second plurality of protected application programs,
wherein the communication monitor module is further communicably coupled to the second protected container, and configured to manage access to the second protected application data by implementing a second access policy wherein the second protected application data is accessible to the second plurality of protected application programs, and wherein the second protected application data is inaccessible to the non-protected application program unless a second exception policy is complied with. In this third embodiment, the second access policy further includes the first protected application data and the non-protected application data are accessible to the second plurality of protected application programs.

In this third embodiment, the second access policy further includes the second protected application data is inaccessible to the first plurality of protected application programs unless both the first exception policy and the second exception policy are complied with.

### BRIEF DESCRIPTION OF THE DRAWINGS

Embodiments of the application are disclosed hereinafter with reference to the drawings, in which:

FIG. 1A shows a simplified architecture of a mobile device according to one embodiment of the application;

FIG. 1B shows an implementation architecture of the mobile device of FIG. 1A;

FIG. 2 shows a flow sequence for installing and configuring a protected container in a mobile device;

FIG. 3 shows, a flow sequence for limiting data access within a mobile device of FIG. 1B;

FIG. 4 illustrates a mobile device architecture having a plurality of protected containers which are logically separate from each other and configured at same protection level; and

FIG. 5 illustrates a mobile device architecture having a plurality of protected containers which are logically separate from each other and configured at different protection levels.

### DETAILED DESCRIPTION

In the following description, numerous specific details are set forth in order to provide a thorough understanding of various illustrative embodiments of the application. It will be understood, however, to one skilled in the art, that embodiments of the application may be practiced without some or all of these specific details. In other instances, well known process operations have not been described in detail in order not to unnecessarily obscure pertinent aspects of embodiments being described. In the drawings, like reference numerals refer to same or similar functionalities or features throughout the several views.

As used in the description and claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

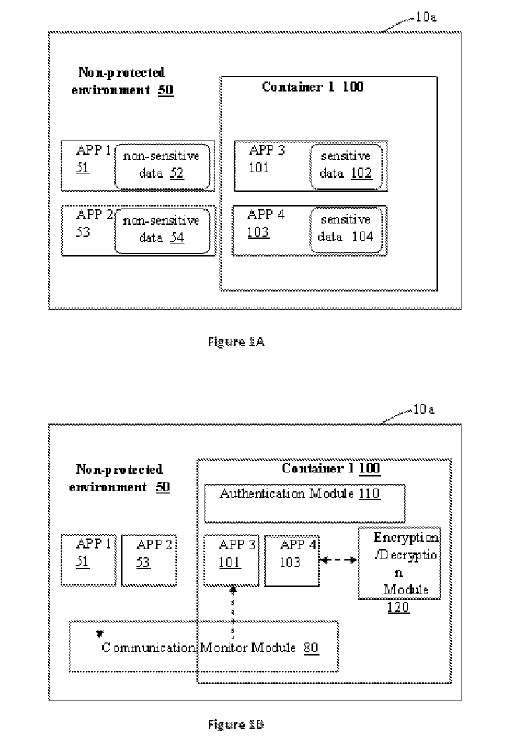

FIG. 1A shows a simplified architecture of a mobile device 10a according to a first embodiment of the application. The mobile device 10a includes, amongst others, a computer-readable storage or memory, at least one processor communicably coupled to the computer-readable storage and configured to execute computer-executable code stored on the computer-readable storage, a display unit (e.g. touch screen), input and output devices. The computer-readable storage includes a non-protected environment and one or more protected containers or environments, which are logically separate from one another.

In the non-protected environment 50, application programs installed therein are hereinafter referred to as “non-protected application programs” 51, 53, etc., and application data stored therein, and associated with the non-protected application programs are hereinafter referred to as “non-protected application data” 52, 54, etc. The non-protected application data refers to data of non-sensitive or less sensitive nature or lower privacy level. Access to non-protected application programs 51, 53 and non-protected application data 52, 54, and communication among non-protected application programs 51, 53 are generally unrestricted.

In the protected environment 100 (hereinafter “protected container”), application programs installed therein are hereinafter referred to as “protected application programs” 101, 103 etc and application data stored therein and associated with the protected application programs are hereinafter referred to as “protected application data” 102, 104. The protected application data refers to data of more sensitive nature or higher privacy level. Access to protected application data 102, 104 is generally restricted to protected application programs 101, 103. Particularly, access to a protected container is allowed only after successful authentication of a received password. Examples of password include, but are not limited to, alpha and/or numeric characters, and biometric information. Communication among protected application programs which are installed within the same protected container is generally unrestricted. Communication from protected application programs to non-protected application programs is generally unrestricted, whereas communication from non-protected application programs to protected application programs is restricted with certain exceptions as will be described later in the present disclosure.

FIG. 1B illustrates an implementation architecture of the mobile device 10a of FIG. 1A, which is provided with a non-protected environment 50 and a first protected container 100. The non-protected environment 50 is configured to store non-protected application programs 51, 53 and non-protected application data 52, 54 associated with the non-protected application programs 51, 53. The first protected container 100 is configured to store one or more application programs (hereinafter “first plurality of protected application programs” 101, 103) and application data associated with the first plurality of protected application programs (hereinafter “first protected application data” 102, 104) therein. The non-protected environment and the first protected container of the computer-readable storage are logically separate. The first protected container 100 further comprises a first authentication module 110 and a first cryptography module 120. The first authentication module 110 is configured to verify receipt of authorized first password associated with the first protected container. Particularly, when a user wishes to access first protected application program 101, 103 and/or first protected application data 102, 104, the first authentication module 110 is initiated. The user is allowed access only if authorized first password is received. The first cryptography module 120 is configured to render the first protected application data 102, 104 in encrypted form if authorized first password is not received, and in decrypted form if authorized first password is received. Particularly, system-level encryption may be employed i.e. plain data are encrypted when they are written to files and the files will be decrypted automatically when they are read by the first protected application program 101, 103. This allows encryption/decryption procedures which are transparent to the first protected application program 101, 103 and therefore the functionalities of the first protected application program 101, 103 are not affected. By decrypting data only when password authentication is successful, an unauthorized user cannot access the first protected application program 101, 103 and data 102, 104 by rooting the mobile device.

A communication monitor module 80 is provided to monitor communication requests within the non-protected environment, within the protected environment, and traversing therebetween. Accordingly, the communication module 80 is communicably coupled to the non-protected environment 50 and the first protected container 100. Communication requests to be monitored includes, but not limited to, intents (in Android system), sockets and pipes. The communication monitor module 80 serves as a firewall to the protected container 100, more particularly to manage or limit access to protected application programs 101, 103 and data 102, 104 based on preconfigured access policies and exception policies.

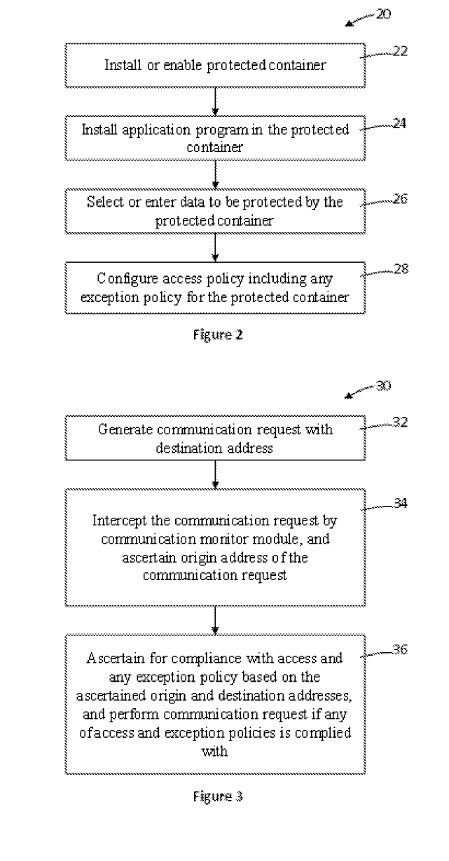

A method for installing and configuring a protected container in a mobile device is described with reference to the flow sequence 20 of FIG. 2. Prior to installing or enabling the first protected container, the mobile device may be pre-configured at the device manufacturer to allow implementation of non-protected and protected environments.

In block 22, a user installs or enables a first protected container.

In block 24, a user installs a first protected application program in the first protected container. This may be performed by installing the application program with a modified path, redefining the owner of the application program or other suitable methods.

In block 26, the user selects or enters first protected application data to be protected by the first protected container. This may be performed by manual data entry, selection via the user interface of the first protected application program or other suitable methods.

In block 28, the user configures access policy for the first protected container (hereinafter referred to as “first access policy”) to limit access to the first protected application data. The first access policy includes specifying which data are to be stored in the protected container and which data are to be stored outside the protected container, i.e. in the non-protected environment. The user may further configure exception policy for the first protected container (hereinafter referred to as “first exception policy”) to manage communication requests from non-protected application.

After the first protected container is installed (block 22), any user who wishes to access the first protected application program and/or first protected application data has to be successfully authenticated by the first authentication module before allowing access.

It is to be appreciated that the flow sequence of FIG. 2, in part or in whole, may be performed or repeated when additional protected containers are to be installed. Further, the steps described in blocks 24, 26 and 28, individually or in combination, may be selectively performed. For example, block 24 may be selectively performed when a user wishes to install new application programs in the first protected container; block 26 may be selectively performed when there is increased in privacy of certain non-protected data; block 28 may be performed when user wishes to change access and/or exception policies.

Block 26 is further illustrated with reference to FIG. 1B where App 1 and App 2 are installed in a non-protected file system, while App 3 and App 4 are installed in a first protected container. For example, App 1 may be an address book which stores some non-sensitive contacts while App 3 is another address book which stores more sensitive contacts whose access is to be restricted. App 3 may be a logical copy of App 1. App 1 or App 2 cannot access the contacts stored in or associated with App 3, but App 3 or App 4 may be able to access the contacts stored by or associated with App 1. The sensitive contacts could be stored in App 3 or chosen to be protected in various ways including, but not limited to, data entry of contacts individually via App 3's user interface, and having App 3 access App 1's contact list via content provider to select contacts therefrom. The contacts to be protected will be transferred to App 3's storage by the content provider. Thereafter, only the authenticated user can enter the first protected container and run App 3 to access the sensitive contacts stored therein.

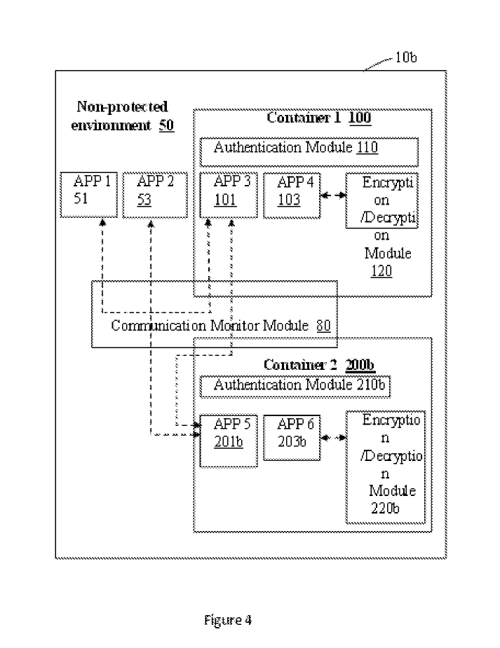

A method for managing or limiting data access within a mobile device, illustrated in FIG. 1B, having a non-protected environment and a first protected container is described with reference to the flow sequence 30 of FIG. 3. The flow sequence 30 of FIG. 3 is initiated when any application program (e.g. App A) is instructed to access data from or associated with another application program (e.g. App B).

In block 32, when App A is instructed to access data from or associated with App B, App A generates a communication request which includes destination address as App B. The generated communication request is to be passed to App B to be processed.

In block 34, the communication monitor module intercepts the communication request, ascertains from the communication request its origin address as App A and its destination address as App B.

In block 36, based on the first access policy and any first exception policy as configured earlier, the communication monitor module ascertains whether any of the policies is complied with. If the first access policy or first exception policy is complied, the communication request is performed. Otherwise, the communication request is blocked.

The first access control policy may include, but are not limited to:

(a) If both origin and destination addresses correspond to the non-protected environment, the communication request is to be performed. (In other words, non-protected application data is accessible to non-protected application programs.)

(b) If both origin and destination addresses correspond to the first protected container, the communication request is to be performed. (In other words, first protected application data is accessible to first plurality of protected application programs.)

(c) If the origin address corresponds to the first protected container but the destination address corresponds to the non-protected environment, the communication request is to be performed. (In other words, non-protected application data is accessible to first plurality of protected application programs.)

(d) If the destination address corresponds to the first protected container but the origin address does not correspond to the first protected container, both origin and destination addresses will be determined whether they conform to the first exception policy. If both origin and destination addresses comply with the first exception policy, the communication request is to be performed. If both origin and destination addresses do not comply with the first exception policy, the communication request would not be performed or would be blocked. (In other words, first protected application data is inaccessible to non-protected application programs unless the first exception policy is complied with.)

The first exception policy includes identification of at least one first pre-specified origin address and at least one first pre-specified destination address for which access to the first protected application data would be allowed. The first exception policy is complied with if origin and destination addresses in the communication request comply with any first pre-specified origin address and any first pre-specified destination address identified in the first exception policy. As an additional condition in certain embodiments, the first exception policy is complied with if an authorized first password associated with the first protected container is further received.

In addition to the foregoing flow sequence 30, a verification step may precede or be interposed within the flow sequence 30. The verification step is to verify for receipt of authorized password at authentication module of a protected container if access to application program or data of a protected container is required.

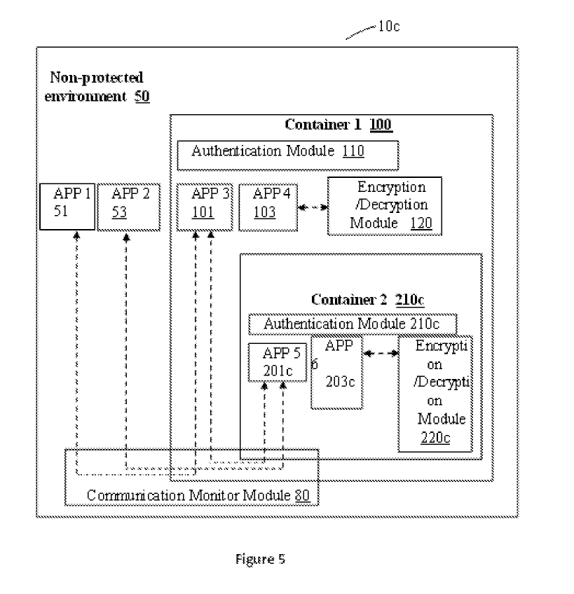

FIG. 4 illustrates a mobile device architecture according to a second embodiment. The mobile device 10b includes a plurality of protected containers (e.g. first protected container 100 and second protected container 200b) which are logically separate from each other and configured at same protection level. User access to each protected container is subject to independent authentication. The embodiment of FIG. 4 may be employed where multiple protected containers are to be independent of each other and communication between protected containers may be limited. For example, one protected container is designated for business while the other protected container is designated for family or personal purpose.

It is to be appreciated that the foregoing description on the first protected container, including architecture, access and exception policies, is replicated (with corresponding changes to the ordinal adjectives) the second (and any subsequent) protected container.

In addition, the access policies (first and second access policies) of the first and the second protected containers may further include: (e) if the origin address corresponds to one of the first and the second protected containers, and the destination address corresponds to the other one of the first and the second protected containers, both origin and destination addresses will be determined whether they conform to the first and the second exception policy. If both origin and destination addresses comply with both exception policies, the communication request is to be performed. If both origin and destination addresses do not comply with both exception policies, the communication request would be blocked. (In other words, first and second protected application data are inaccessible to second and first protected application program respectively unless the first and the second exception policy are both complied with.)

FIG. 5 illustrates a mobile device architecture according to a third embodiment. The mobile device 10c includes a plurality of protected containers which are logically separate from each other and configured to provide different protection levels. Particularly, a second protected container 200c is nested or contained within a first protected container 100. The nesting arrangement provides a hierarchical structure for implementing differentiated protection levels. In other words, an inner or higher nesting container has higher level of protection and may be designated to store application programs and application data of higher privacy level; an outer or lower nesting container has lower level of protection and may be designated to store application programs and corresponding application data of lower privacy level; non-protected environment (i.e. outside protected containers) are designated to store application programs and application data of lowest privacy level. User access to the outer nesting container requires few level of authentication while user access to the inner nesting container requires multiple levels of authentication.

It is to be appreciated that the foregoing description on the first protected container 100, including architecture, access and exception policies, is applicable to the first protected container 100 of FIG. 5.

In addition, the second protected container 200c comprises a second authentication module 210c, a second cryptography module 220c. The second protected container is logically separate from the non-protected environment and the first protected container, and is configured to store at least a second protected application program 201c, 203c, etc and second protected application data associated with the second protected application program. The second authentication module is configured to verify receipt of the authorized second password. The second cryptography module 220c is configured to render the second protected application data in encrypted form if the authorized first password and the authorized second password are both not received, and in decrypted form if the authorized first password and the authorized second password are both received. The communication monitor module 80 is further communicably coupled to the second protected container 200c, and configured to manage or limit access to the second protected application data by implementing a second access policy.

The second access control policy may include, but are not limited to:

(a) If both origin and destination addresses correspond to the non-protected environment, the communication request is to be performed. (In other words, non-protected application data is accessible to non-protected application programs.)

(b) If both origin and destination addresses correspond to the second protected container, the communication request is to be performed. (In other words, second protected application data is accessible to second protected application program.)

(c) If the origin address corresponds to the second protected container and the destination address corresponds to the non-protected environment or first protected container, the communication request is to be performed. (In other words, non-protected application data and first protected application data are accessible to second protected application program.)

(d) If the destination address corresponds to the second protected container and the origin address corresponds to the non-protected application program or the first protected container, both origin and destination addresses will be determined whether they conform to the second exception policy. If both origin and destination addresses comply with the second exception policy, the communication request is to be performed. If both origin and destination addresses do not comply with the second exception policy, the communication request would be blocked. (In other words, second protected application data is inaccessible to non-protected application programs and the first plurality of protected applications unless the second exception policy is complied with.)

[symbol]

In the embodiments having two or more protected containers as illustrated in FIGS. 4 and 5, the second exception policy includes identification of at least one second pre-specified origin address and at least one second pre-specified destination address for which access to the second protected application data would be allowed. The second exception policy is complied with if the communication request complies with any second pre-specified origin and destination addresses identified in the second exception policy. As an additional condition in certain embodiments, the second exception policy is complied with if an authorized first password associated with the first protected container and an authorized second password associated with the second protected container are further received.

Embodiments of the application provide several advantages including, but not limited to, the following:

the application proposes an isolated environment or protected container implementation for mobile devices, including smart phones and tablets. Application programs and application data which are considered more sensitive or have higher privacy level are stored in the protected environment, and generally cannot be accessed by application programs which are outside the protected environment. Only the authenticated user can enter the protected environment and access the sensitive or private data.

For convenience, in the protected environment, the authenticated user can access the non-sensitive data stored outside the protected environment. This protects user's sensitive data without compromising usability.

For convenience and without comprising on security, in the non-protected environment, the authenticated user can access sensitive data, which is stored in the protected environment, only in certain circumstances as specified in an exception policy.

Protection level may be increased by nesting a container within another container. In a nested arrangement, application programs and application data with higher protection needs can be stored in an inner or nested container. In order to access these programs and data in the nested container, a user has to be successfully authenticated by two or more authentication modules depending on the level of nesting. Accordingly, differentiated protection levels can be implemented by providing protected containers having different nesting levels.

Other embodiments will be apparent to those skilled in the art from consideration of the specification and practice of the application. Furthermore, certain terminology has been used for the purposes of descriptive clarity, and not to limit the disclosed embodiments of the application. The embodiments and features described above should be considered exemplary.

1. A mobile device comprising:
a computer-readable storage and a processor communicably coupled to the processor, the computer-readable storage including:
a non-protected environment which is configured to store at least a non-protected application program and a non-protected application data associated with the non-protected application program,
a first protected container which is logically separate from the non-protected environment, and configured to store a first plurality of protected application programs and a first protected application data associated with the first plurality of protected application programs, and
a communication monitor module communicably coupled to the non-protected environment and the first protected container, and configured to manage access to the first protected application data by implementing a first access policy wherein the first protected application data is accessible to the first plurality of protected application programs, and wherein the first protected application data is inaccessible to the non-protected application program unless a first exception policy is complied with.

2. The device of claim 1, wherein the first access policy further includes the non-protected application data is accessible to any of the first plurality of protected application programs and the non-protected application program.

3. The device of claim 1, wherein the first protected container further includes: a first authentication module configured to verify receipt of an authorized first passcode associated with the first plurality of protected programs, and a first cryptography module configured to render the first protected application data in encrypted form if the authorized first password is not received, and in decrypted form if the authorized first password is received.

4. The device of claim 1, wherein the first exception policy is complied with if any first pre-specified origin address and any first pre-specified destination address identified in the first exception policy are complied with.

5. The device of claim 1 wherein the communication monitor module is further configured to:
intercept a communication request generated by any of the non-protected application program and the first plurality of protected application programs,
ascertain an origin address and a destination address of the communication request,
ascertain for compliance with at least one of the first access policy and the first exception policy based on the ascertained origin address and the ascertained destination address, and
based on the ascertained compliance, perform or block the communication request.

6. The device of claim 1, wherein the computer-readable storage further includes:
a second protected container which is logically separate from the non-protected environment and the first protected container, and configured to store a second plurality of protected application programs and a second protected application data associated with the second plurality of protected application programs,
wherein the communication monitor module is further communicably coupled to the second protected container, and configured to manage access to the second protected application data by implementing a second access policy wherein the second protected application data is accessible to the second plurality of protected application programs, and wherein the second protected application data is inaccessible to the non-protected application program unless a second exception policy is complied with.

7. The device of claim 6, wherein the second access policy further includes the second protected application data is inaccessible to the first protected application program unless both the first exception policy and the second exception policy are complied with,
wherein the first access policy further includes the first protected application data is inaccessible to the second protected application program unless both the first exception policy and the second exception policy are complied with.

8. The device of claim 6, wherein the second access policy further includes the first protected application data and the non-protected application data are accessible to the second plurality of protected application programs.

9. The device of claim 8, wherein the second access policy further includes the second protected application data is inaccessible to the first plurality of protected application programs unless both the first exception policy and the second exception policy are complied with.

10. The device of claim 6, wherein the second exception policy is complied with if any second pre-specified origin address and any second pre-specified destination address identified in the second exception policy are complied with.

11. The device of claim 6, wherein the communication monitor module is further configured to:
intercept a communication request generated by any of the non-protected application program, the first plurality of protected application programs and the second plurality of protected application programs,
ascertain an origin address and a destination address of the communication request,
ascertain for compliance with at least one of the first access policy and the first exception policy based on the ascertained origin address and the ascertained destination address,
ascertain for compliance with at least one of the second access policy and the second exception policy based on the ascertained origin address and the ascertained destination address, and
based on the ascertained compliance, perform or block the communication request.

12. The device of claim 1, wherein the first exception policy is user-specified.

13. The device of claim 1, wherein one of the first plurality of protected application programs is a logical copy of the non-protected application program.

14. A method implementable at a mobile device which comprises a computer-readable storage and a processor communicably coupled to the processor, the computer-readable storage including: a non-protected environment which is configured to store at least a non-protected application program and a non-protected application data associated with the non-protected application program, a first protected container which is logically separate from the non-protected environment, and configured to store a first plurality of protected application programs and a first protected application data associated with the first plurality of protected application programs, and a communication monitor module communicably coupled to the non-protected environment and the first protected container, the method comprising:
at the communication monitor module, managing access to the first protected application data, including implementing a first access policy wherein the first protected application data is accessible to the first plurality of protected application programs, and wherein the first protected application data is inaccessible to the non-protected application program unless a first exception policy is complied with.

15. The method of claim 14, wherein the first access policy further includes the non-protected application data is accessible to any of the first plurality of protected application programs and the non-protected application program.

16. The method of claim 14, wherein the first protected container further includes: a first authentication module and a first cryptography module, the method further comprising:
at the first authentication module, verifying receipt of an authorized first passcode associated with the first protected container; and
at the first cryptography module, rendering the first protected application data in encrypted form if the authorized first password is not received, and in decrypted form if the authorized first password is received.

17. The method of claim 14, wherein the first exception policy is complied with if any first pre-specified origin address and any first pre-specified destination address identified in the first exception policy are complied with.

18. The method of claim 14, wherein managing access to the first protected application data includes:
intercepting a communication request generated by any of the non-protected application program and the first plurality of protected application programs;
ascertaining an origin address and a destination address of the communication request;
based on the ascertained origin address and the ascertained destination address, ascertaining for compliance with at least one of a first access policy and a first exception policy which are associated with the first protected container; and
based on the ascertained compliance, performing or blocking the communication request.

19. The method of claim 14, wherein the computer-readable storage further includes a second protected container which is logically separate from the non-protected environment and the first protected container, and configured to store a second plurality of protected application programs and a second protected application data associated with the second plurality of protected application programs, wherein the communication monitor module is further communicably coupled to the second protected container, the method further comprising:
at the communication monitor module, managing access to the second protected application data, including implementing a second access policy wherein the second protected application data is accessible to the second plurality of protected application programs, and wherein the second protected application data is inaccessible to the first plurality of protection application programs unless a second exception policy is complied with.

20. The method of claim 19, wherein the second access policy further includes the second protected application data is inaccessible to the first protected application program unless both the first exception policy and the second exception policy are complied with,
wherein the first access policy further includes the first protected application data is inaccessible to the second protected application program unless both the first exception policy and the second exception policy are complied with.
